(19) United States
(12) Patent Application Publication
(10) Pub. No.: US 2014/0332082 A1
(43) Pub. Date: Nov. 13, 2014

(54) LEAKAGE PROTECTION PADS

(71) Applicant: CONOCOPHILLIPS COMPANY, Houston, TX (US)

(72) Inventor: Laurie Forbes MACKAY, Aberdeenshire (GB)

(73) Assignee: CONOCOPHILLIPS COMPANY, Houston, TX (US)

(21) Appl. No.: 14/264,820

(22) Filed: Apr. 29, 2014

Related U.S. Application Data
(60) Provisional application No. 61/821,912, filed on May 10, 2013.

(51) Int. Cl. F16L 55/168

(52) U.S. Cl. CPC F16L 55/168
USPC 137/1; 137/312

(57) ABSTRACT

The invention relates to the prevention of small leakages from transfer lines used for transferring liquids, e.g. oil, between ships, oil platforms and other structures or vessels, where the transfer lines extend over open water. In such situations, small amounts of oil can leak from e.g. a corroded joint, causing an environmental impact which may be a notifiable event. A pad may be fastened around a joint or other part of the transfer line which may be at risk of leakage or seepage, which is capable of soaking up the small volumes of liquid which are likely to be involved (a liter or so). The pad includes a sorbent zone and an outer impermeable layer which may have a transparent or translucent portion. The pad is preferably also equipped with a floatation element.

### CROSS-REFERENCE TO RELATED APPLICATIONS

This application is a non-provisional application which claims benefit under 35 USC §119(e) of and priority to U.S. Provisional Application Ser. No. 61/821,912 filed 10 May, 2013, entitled “LEAKAGE PROTECTION PADS,” which is incorporated by reference herein in its entirety.

### STATEMENT REGARDING FEDERALLY SPONSORED RESEARCH OR DEVELOPMENT

None.

### FIELD OF THE INVENTION

This invention relates to methods and devices for helping to prevent environmental contamination caused by seepage or leakage of small quantities of liquid, e.g. hydrocarbon liquid, from a line or pipe into open water, such as the sea. The invention is especially suitable for helping prevent seepage or leakage of oil from a joint or connection, such as temporary joint or connection, in a line for transferring oil at sea.

### BACKGROUND OF THE INVENTION

The uncontrolled discharge, especially into the sea, of even a small volume of potentially environmentally damaging liquid is to be prevented at all costs. For this reason, discharge of even one liter or less of oil into the sea may constitute a reportable incident. For example in United Kingdom waters the discharge any quantity of oil, however small, must be reported through the submission of a “PON 1” (Petroleum Operations Notice 1) to the UK Government's Department of Energy and Climate Change.

Apart from the undesirable environmental impact, it will be appreciated that the filing of such a notice can result in the diversion of considerable resource to attend to the necessary procedures.

The inventor attended an incident in the U.K. North Sea where 0.5 Liters of fuel oil leaked from pipe joint in an operation to transfer fuel oil from a supply ship to an offshore oil rig (“bunkering”). This resulted in a PON 1 notification being made.

The invention was conceived as a simple but potentially highly effective way of avoiding such environmental impact in the future, and also avoiding the diversion of resources required for the filing of a PON 1, especially for such a small volume of liquid.

### BRIEF SUMMARY OF THE DISCLOSURE

According to one embodiment of the invention, a method of containing liquid leaking, weeping or seeping from a selected part of a liquid transfer line comprises: a) providing a pad comprising a sorbent zone and a fastener; b) fastening the pad on the selected part of the liquid transfer line; and c) transferring liquid through the transfer line whilst the transfer line extends over open water; whereby if any liquid leaks from the selected part of the transfer line, it passes into the sorbent zone.

In this way, it may be possible to contain relatively small leaks thereby avoiding both environmental impact and the time and expense of reporting an incident. A selected part of the transfer line which is considered to present a risk of leaking, seeping or weeping liquid may be identified in advance and the pad fastened on the selected part prior to transferring liquid through the line. Often, the place where there is a risk of a leak will be a joint or connection of some sort; joints can work loose or become unduly stressed, or can be subject to corrosion, causing slight weeping, leakage or seepage. In some UK North Sea locations, a leak is defined as 4 or more drips per minute, whilst a seep is defined as 3 or fewer drips per minute, but much larger escapes than this may be caught by the inventive pad.

Commonly, the liquid concerned is oil, whether it be crude oil, fuel oil or some other liquid petroleum product. Transfers which are particularly at risk of creating reportable incidents include those from or to ships, floating production and storage vessels (“FPSOs”), floating storage vessels (“FSOs”), drilling or production platforms or shore terminals. Transfer lines can be subject to unpredictable stresses particularly where the transfer is made from or to a floating vessel on open sea, especially if the sea is at all rough.

The pad may be inspected either during or after the liquid transfer operation by removing it and checking for leaked liquid in the sorbent zone of the pad. If the liquid is oil it will normally show up very easily, e.g. on a light colored sorbent. Alternatively, the pad may be inspected whilst still in place on the transfer line; this can be facilitated by the incorporation of one or more transparent or translucent zones on the pad as will be discussed further below.

Commonly, liquid transfer operations involve the temporary assembly of the transfer line, e.g. connecting a number of sections of line together via flanged joints. A pad can be fastened on one or more of the joints. On disassembly of the transfer line, the pad or pads can be removed and inspected. Any contamination can be noted and the joint then inspected to see if it needs tightening or for signs of wear, corrosion or other damage. Any contaminated pad can have its sorbent zone removed and replaced with uncontaminated sorbent.

The pad itself may comprise a sorbent zone and an impermeable layer extending partly around the sorbent zone. The impermeable layer helps to prevent the sorbent zone being soaked with water from splashes, etc. It also helps to avoid any contaminant entering the sea if the pad is inadvertently dropped into the sea. By preventing the sorbent from becoming waterlogged, it may also allow the pad to float to allow easy recovery. The impermeable layer may have high visibility, e.g. fluorescent coloring, or it may be transparent or translucent to allow easy inspection of the sorbent zone, or different parts of it may be colored or transparent/translucent.

The pad may be provided with a liquid (e.g. oil) permeable layer extending partly around the sorbent zone, specifically in the area which is facing the liquid transfer line when the pad is installed. It's also possible for there to be no liquid permeable layer and for the sorbent zone simply to be exposed in this area. The sorbent zone may be a in the form of a sorbent member which may be removable, either through a simple aperture in the impermeable layer (which would face the transfer line when the pad is installed) or alternatively via a closable flap. For example a liquid permeable layer may be attached to the impermeable layer e.g. by hook and loop fastenings strips (e.g. Velcro®) to form a closable flap through which the sorbent member may be removed and replaced.

A floatation element may be incorporated into the pad, either in the form of one or more discrete floats attached to the exterior of the pad or embedded within the pad, or alternatively as a floatation layer extending all or part of the way around the sorbent zone. In the latter case, the floatation layer may be interposed between the impermeable layer and the sorbent zone. The floatation element or layer may be made from a non-absorbent material such as a closed cell foam material, e.g. closed cell polyurethane foam. It may be partly or wholly transparent or translucent. It may also be colored so as to be highly visible.

### BRIEF DESCRIPTION OF THE DRAWINGS

A more complete understanding of the present invention and benefits thereof may be acquired by referring to the follow description taken in conjunction with the accompanying drawings in which:

FIG. 1 is a plan view of a pad in accordance with the invention;

FIG. 2 is a section on the line A-A′ in FIG. 1;

FIG. 3 is a section through a sorbent member used in the pad of FIGS. 1 and 2, on an enlarged scale;

FIG. 4 is a schematic representation of the pad of FIGS. 1 and 2 in place on a joint in a liquid transfer line; and

FIG. 5 is a view similar to FIG. 4 but, for the purpose of clarity, without the sorbent member so that the joint can be seen through the pad.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

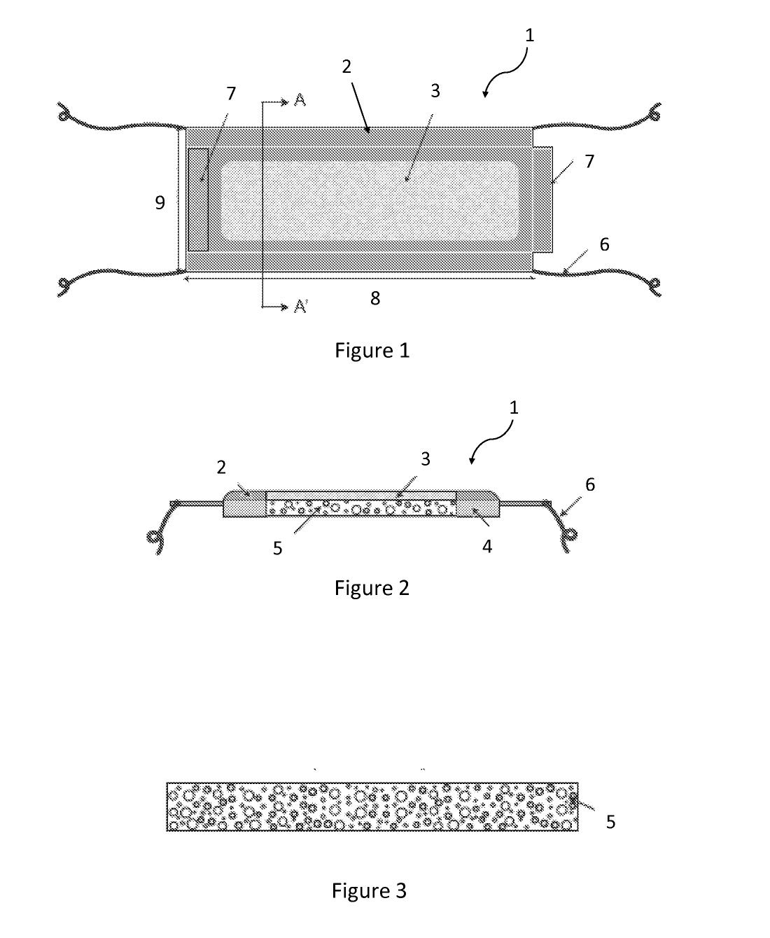

Referring firstly to FIGS. 1 and 2, an exemplary environmental protection pad in accordance with the invention is shown at 1. In FIG. 1, the outer face of the pad is shown, that is to say the face which will be on the outside when the pad is in place on a pipe joint. FIG. 2 shows a section through the pad with the outer face uppermost and the inner face, which will be adjacent a pipe joint when the pad is installed, lowermost in the Figure.

The pad 1 is of flat rectangular shape and comprises an outer layer 2 of high visibility, fluorescent material which is also fire-retardant, e.g. PVC coated fabric with a fire retardant additive. A portion 3 of the outer layer is made from a fire-retardant transparent or translucent material. Secured, e.g. by adhesive, to the inner surface of the outer layer 2 and extending around the periphery of the pad is a floatation member 4 made from non-absorbent closed cell polyurethane foam. The floatation member 4 has high visibility, fluorescent coloring.

Retained within the floatation member is an absorbent zone 5 of wool (see also FIG. 3). Sheep's wool is a surprisingly effective material for absorbing and retaining oil. The wool may be sufficiently compacted to form a distinct, removable absorbent member. Many other materials may be substituted for the wool, such as vermiculite, sawdust, paper pulp or synthetic absorbents. In the event that the sorbent material is insufficiently compacted or cohesive to be removed without it disintegrating, the material may be contained within a thin, transparent or translucent permeable layer such as perforated PVC or some other polymer, or netting or gauze. The pad is ideally of light coloring, e.g. white or off-white, since any oil soaked into the pad will then be visible easily.

Enclosed within a seam on each of the longer edges of the outer impermeable layer 2 of the pad is a nylon fastening cord 6, in a high visibility color such as red. A tab on one of the short edges of the outer layer 2 has a strip of hook and loop fastening material 7 (such as is marketed under the trade name Velcro ®) whilst another strip 7 of complementary fastening material is secured to the other end of the outer layer 2.

This exemplary pad has a longitudinal dimension 8 of approximately 870 mm, whilst the transverse dimension 9 is approximately 265 mm. The thickness of the pad assembly is about 70 mm, of which 50 mm is the sorbent member 5.

This pad 1 is designed to fit the flange joints in a pipeline used in a diesel fuel bunkering operation, where the diesel is pumped from a supply vessel through a temporary pipeline onto a rig e.g. in the UK North Sea. The pipeline is assembled from relatively rigid sections of steel pipe immediately before the bunkering operation and then disassembled once the operation is finished. Pads 1 are fitted over each joint of the pipeline as it is assembled, and then removed when the pipeline is disassembled. Alternatively, only the pipe joints in that part of the pipeline which extends over open water are fitted with pads.

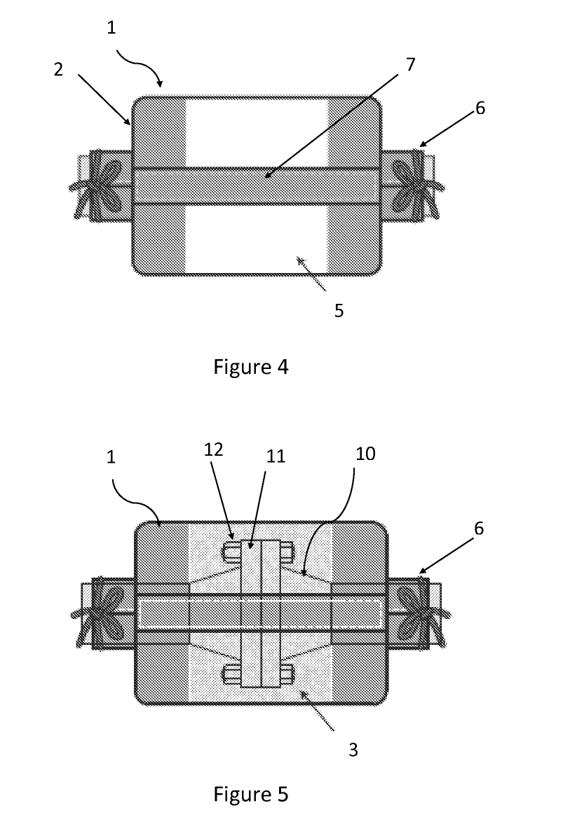

FIGS. 4 and 5 show the pad 1 in place on a pipe joint 10. The hook and loop fastening strips 7 hold the ends of the pad 1 around the pipe joint 10, whilst the long edges of the pad are secured around the pipe on each side of the joint using the nylon cords 6. FIG. 5 shows the pad with the sorbent member 5 removed so that the details of the joint 10 may be seen through the pad; obviously it would not normally be intended for the pad to be fitted without an absorbent member 5. The joint 10 is a flange joint, where each of the two sections of pipe to be joined terminates in a flange 11 with holes for bolts 12.

In FIG. 4, the white wool sorbent material 5 may be seen through the translucent portion of the outer layer 2. As the pipeline extends across the open sea between the supply vessel and the rig, it will be understood that considerable stresses may be imparted to the joint, which can result in the joint becoming deformed sufficiently to cause leaking, seeping or weeping of oil. Unless the volumes are very small, the presence of oil in the sorbent 5 should be visible through the translucent portion 3 of the outer layer whilst the pad is still in place. Special care can then be taken when removing the pad that none of the oil enters the environment. The wool sorbent member 5 can be removed and replaced.

If by some chance a pad is dropped when it is being removed, and it lands in the sea, the floatation member 4 will ensure that that the pad floats high in the water to assist visibility and recovery. If the pad is contaminated, then provided it remains oriented with the sorbent facing upwards and is recovered quickly, there is a reasonable chance of avoiding oil entering the sea.

In this exemplary embodiment of the invention, the sorbent has a capacity of 0.51-1.01. However, it can be envisaged that many different types and sizes of pipeline may benefit from this general concept and it may well be that larger capacity pads would be useful.

There are many variants of the design, for example a floatation layer extending around all or most of the pad could replace the member 4, or the outer layer 2 could curve round the longitudinal edges of the pad and extend part of the way over the inner face, to help retain the floatation member and/or sorbent zone or member. A great many different options for fastening the pad to the pipe can be envisaged.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method of containing liquid leaking, weeping or seeping from a selected part of a liquid transfer line, the method comprising:
a) providing a pad comprising a sorbent zone;
b) fastening the pad on the selected part of the liquid transfer line; and
c) transferring liquid through the transfer line whilst the transfer line extends over open water;
d) whereby, if liquid leaks from the selected part of the transfer line, it passes into the sorbent zone.

2. The method according to claim 1, including identifying a selected part of the transfer line which is considered to present a risk of leaking, seeping or weeping liquid, and fastening the pad on the selected part prior to transferring liquid through the line.

3. The method according to claim 2, wherein the said selected part is a joint or connection.

4. The method according to claim 2, wherein the joint is a flange joint.

5. The method according to claim 1 wherein the liquid is oil.

6. The method according to claim 5 wherein the line extends from or to a ship, floating production and storage vessel (“FPSO”), floating storage vessel (“FSO”), oil production or drilling platform or shore terminal.

7. The method according to claim 1 further comprising removing the pad and inspecting it to establish whether any liquid has entered the pad.

8. The method according to claim 1 comprising inspecting the pad for signs of leakage whilst it remains in place on the transfer line.

9. The method according to claim 1 wherein the line is assembled temporarily in order to transfer liquid and is disassembled when the liquid transfer is complete.

10. The method according to claim 9 comprising removing the pad when the line is disassembled and inspecting it to establish whether any liquid has entered the pad.

11. A pad for containing liquid leaking, weeping or seeping from a liquid transfer line, the pad comprising:
a) a sorbent zone; and
b) an impermeable layer extending partly around the sorbent zone.

12. The pad according to claim 11, further comprising a liquid permeable layer extending partly around the sorbent zone.

13. The pad according to claim 11, further comprising a floatation element.

14. The pad according to claim 13 wherein the floatation element is a floatation layer interposed between the impermeable layer and the sorbent zone.

15. The pad according the claim 13 wherein the floatation element comprises a non-absorbent foam material.

16. The pad according to claim 11 wherein all or part of the impermeable layer is transparent or translucent.

17. The pad according to claim 12 wherein all or part of the liquid permeable layer is transparent or translucent.

18. The pad according to claim 14 wherein all or part of the floatation layer is transparent or translucent.

19. The pad according to claim 11 wherein the sorbent zone is removable without destroying the impermeable layer.

20. The pad according to claim 11 further comprising a fastener for fastening it to a liquid transfer line.
